(19) United States
(12) Patent Application Publication
(10) Pub. No.: US 2023/0203998 A1
(43) Pub. Date: Jun. 29, 2023

(54) INTERNAL COMBUSTION ENGINE

(71) Applicant: TOYOTA JIDOSHA KABUSHIKI KAISHA, Toyota-shi (JP)

(72) Inventor: Osamu TANIAI, Gotemba-shi (JP)

(73) Assignee: TOYOTA JIDOSHA KABUSHIKI KAISHA, Toyota-shi (JP)

(21) Appl. No.: 18/049,354

(22) Filed: Oct. 25, 2022

(30) Foreign Application Priority Data
Dec. 24, 2021 (JP) 2021-211419

(51) Int. Cl. F02D 35/02; F02D 41/30

(52) U.S. Cl. CPC F02D 35/027; F02D 41/3094

(57) ABSTRACT

A control device for an internal combustion engine is configured to carry out a lean combustion of which excess air factor is 2.0 or more by injecting fuel for creating a homogeneous air-fuel mixture from a first fuel injection valve into a combustion chamber of an engine main body, injecting ignition fuel for creating an ignition air-fuel mixture near an electrode portion of a spark plug from a second fuel injection valve, and igniting the ignition air-fuel mixture, and when occurrence of knocking is detected based on a detection value of a knock sensor during the lean combustion, apply retard correction to each of an ignition timing of the spark plug and an injection timing of the ignition fuel set corresponding to an engine operating state, and apply increase correction to an injection amount of the ignition fuel.

### CROSS REFERENCE TO RELATED APPLICATION

This application claims priority to Japanese Patent Application No. 2021-211419 filed on Dec. 24, 2021, incorporated herein by reference in its entirety.

### BACKGROUND

### 1. Technical Field

The present disclosure relates to an internal combustion engine.

### 2. Description of Related Art

Japanese Unexamined Patent Application Publication No. 2004-3429 (JP 2004-3429 A) discloses, as an internal combustion engine of the related art, that stratified combustion is realized by igniting fuel injected in a compression stroke at the timing when the fuel flows near a spark plug, and when knocking is detected during stratified combustion, knocking is suppressed by retard correction of the ignition timing, and retard correction is applied to an injection timing of the fuel injected in the compression stroke in accordance with the retard correction of the ignition timing. According to JP 2004-3429 A, with this configuration, it is described that the timing at which the fuel injected in the compression stroke flows near the spark plug can be adjusted to the ignition timing, whereby occurrence of misfire due to the retard correction of the ignition timing can be suppressed.

### SUMMARY

A NOx emission amount can be reduced by carrying out lean combustion in which an air-fuel mixture that is leaner than the stoichiometric air-fuel ratio is created in the entire combustion chamber and burned. In the above-mentioned internal combustion engine of the related art, an ignition air-fuel mixture that is richer than the ambient air-fuel mixture is temporarily created near the spark plug by injecting the ignition fuel in the compression stroke and the ignition air-fuel mixture is ignited such that the lean combustion can be stabilized by suppressing occurrence of misfire even when the lean combustion is carried out.

As the injection amount of the ignition fuel is increased and an excess air factor of the ignition air-fuel mixture is lowered (the more the air-fuel ratio of the ignition air-fuel mixture is enriched), the more the lean combustion can be stabilized, but the NOx emission amount increases. Since it is expected that the regulation value of NOx emission amount becomes more and more strict in the future, it is desirable to reduce the injection amount of the ignition fuel as much as possible.

However, as the injection amount of the ignition fuel is reduced, a period during which the excess air factor of the ignition air-fuel mixture is equal to or less than a predetermined excess air factor capable of igniting the ignition air-fuel mixture (hereinafter referred to as “ignitable period of ignition air-fuel mixture”) becomes shorter. To ignite the ignition air-fuel mixture (that is, to stabilize the lean combustion), it is necessary to adjust the ignition timing to the ignitable period of the ignition air-fuel mixture.

In the above-mentioned internal combustion engine of the related art, when knocking occurs, the retard correction is applied to the injection timing of the ignition fuel in accordance with the retard correction of the ignition timing to adjust the ignition timing to the ignitable period of the ignition air-fuel mixture. However, as described above, as the injection amount of the ignition fuel is reduced, the ignitable period of the ignition air-fuel mixture becomes shorter. Therefore, when the injection amount of the ignition fuel is reduced, the ignition timing fails to be adjusted to the ignitable period of the ignition air-fuel mixture even when the retard correction is applied to the injection timing of the ignition fuel in accordance with the retard correction of the ignition timing at the time of occurrence of knocking, and a combustion stability may deteriorate.

The present disclosure has been made focusing on such an issue, and an object of the present disclosure is to ensure the combustion stability when knocking occurs during the lean combustion.

In order to solve the above issue, an internal combustion engine according to a certain aspect of the present disclosure includes: an engine main body; a spark plug provided with an electrode portion disposed to face a combustion chamber of the engine main body; a first fuel injection valve that injects fuel into an intake passage or the combustion chamber of the engine main body; a second fuel injection valve that injects fuel into the combustion chamber; a knock sensor for detecting a vibration of the engine main body; and a control device. The control device is configured to carry out a lean combustion of which excess air factor is 2.0 or more by injecting first fuel for creating a homogeneous air-fuel mixture in the combustion chamber from the first fuel injection valve, injecting ignition fuel for creating an ignition air-fuel mixture near the electrode portion from the second fuel injection valve, and igniting the ignition air-fuel mixture, and when occurrence of knocking is detected based on a detection value of the knock sensor during the lean combustion, apply retard correction to each of an ignition timing of the spark plug and an injection timing of the ignition fuel set corresponding to an engine operating state, and apply increase correction to an injection amount of the ignition fuel.

According to the above aspect of the present disclosure, an ignitable period of the ignition air-fuel mixture can be lengthened by applying the increase correction to the injection amount of the ignition fuel. Therefore, when the retard correction is applied to the injection timing of the ignition fuel together with the retard correction of the ignition timing when knocking occurs, an inability to adjust the ignition timing to the ignitable period of the ignition air-fuel mixture can be suppressed. Accordingly, it is possible to secure combustion stability when knocking occurs during lean combustion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a spark-ignition type internal combustion engine according to an embodiment of the present disclosure and an electronic control unit that controls the internal combustion engine;

FIG. 2 is a schematic view of a combustion chamber as viewed from the cylinder head side;

FIG. 3 shows an example of a fuel injection timing of each of a first fuel injection valve and a second fuel injection valve and an ignition timing in a lean combustion mode according to the embodiment, with an in-cylinder pressure (MPa) on the vertical axis and a crank angle (deg. after top dead center (ATDC)) on the horizontal axis;

FIG. 4 shows a change in a NOx emission amount when only a second fuel injection amount, that is, an excess air factor of a second air-fuel mixture, is changed without changing an average excess air factor of an air-fuel mixture in the combustion chamber is changed under operating conditions with the same engine load and engine rotation speed;

FIG. 5A is a diagram showing a time change of the excess air factor near an electrode portion of a spark plug after a second fuel is injected from the second fuel injection valve;

FIG. 5B is a diagram showing a time change of the excess air factor near the electrode portion of the spark plug when the second fuel injection amount is made smaller than that in the example shown in FIG. 5A; and

FIG. 6 is a flowchart illustrating knocking suppression control executed in the lean combustion mode.

### DETAILED DESCRIPTION OF EMBODIMENTS

Hereinafter, an embodiment of the present disclosure will be described in detail with reference to the drawings. In the following description, similar components are given the same reference numbers.

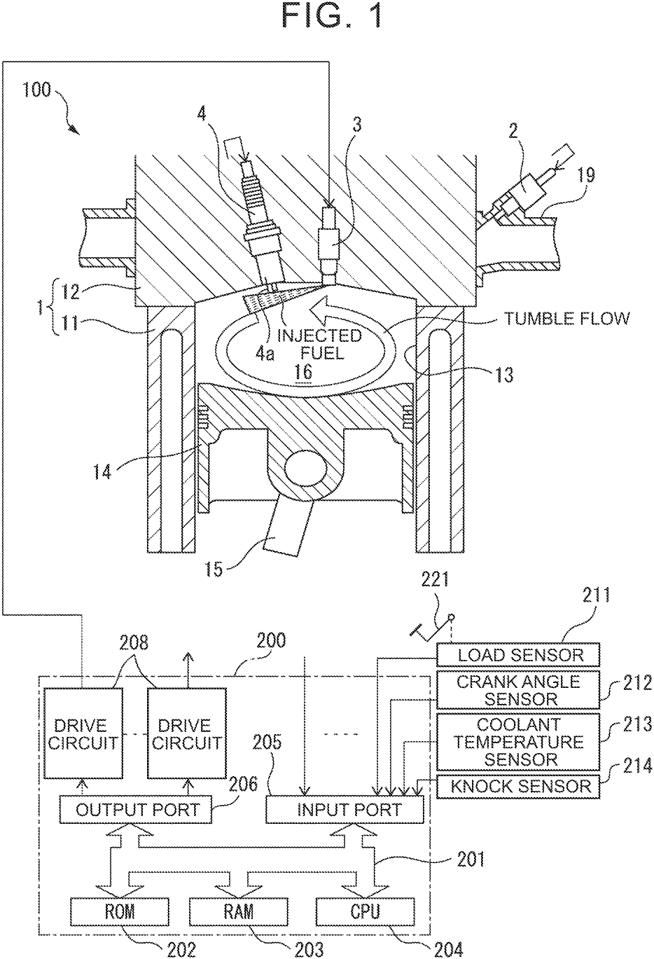

FIG. 1 is a schematic configuration diagram of a spark-ignition type internal combustion engine 100 according to the embodiment of the present disclosure.

As shown in FIG. 1, the internal combustion engine 100 includes an engine main body 1, a first fuel injection valve 2, a second fuel injection valve 3, a spark plug 4, and an electronic control unit 200.

The engine main body 1 includes a cylinder block 11 and a cylinder head 12 fixed to the cylinder block 11.

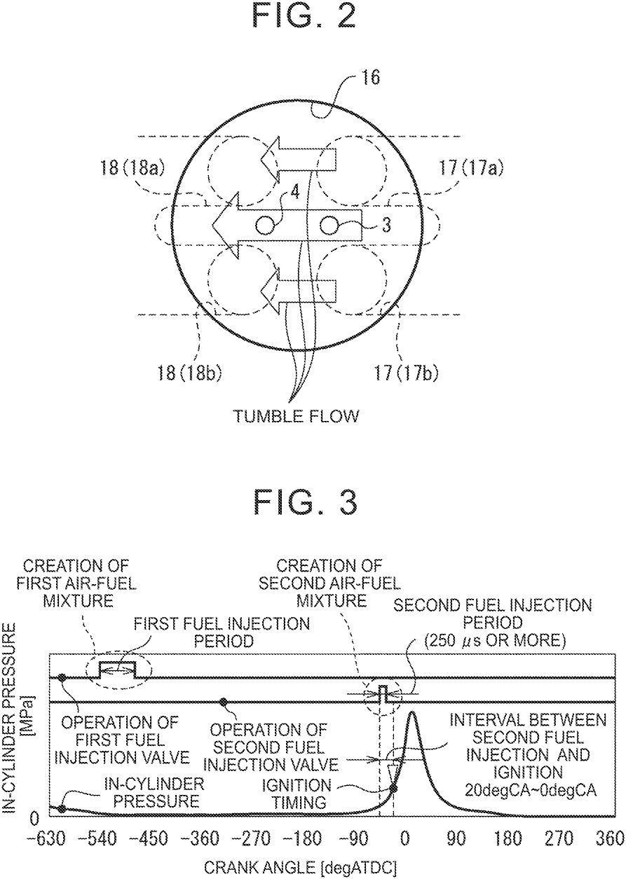

One or more cylinders 13 are provided in the cylinder block 11. A piston 14 that receives a combustion pressure and reciprocates inside the cylinder 13 is housed in the cylinder 13. The piston 14 is connected to a crankshaft (not shown) via a connecting rod 15, and the crankshaft converts a reciprocating motion of the piston 14 into a rotary motion. The space partitioned by an inner wall surface of the cylinder head 12, an inner wall surface of the cylinder 13, and a crown surface of the piston 14 serves as a combustion chamber 16. FIG. 2 is a schematic view of the combustion chamber 16 as viewed from the cylinder head 12 side.

The cylinder head 12 is provided with an intake port 17 (see FIG. 2) constituting a part of an intake passage and an exhaust port 18 (see FIG. 2) constituting a part of an exhaust passage. Each of the intake port 17 and the exhaust port 18 is bifurcated inside the cylinder head 12, and a pair of intake ports 17a, 17b of the bifurcated intake port 17 and a pair of exhaust ports 18a, 18b of the bifurcated exhaust port 18 are opened to the combustion chamber 16.

In the present embodiment, a sectional shape of the intake port 17 and a sectional shape of the combustion chamber 16 are adjusted such that a tumble flow is created in the combustion chamber 16 by the intake air flowing into the combustion chamber 16 through the intake port 17. As shown by the arrow in FIG. 1, the tumble flow according to the present embodiment flows into the combustion chamber 16 from the intake port 17, and then first flows along the top surface of the combustion chamber 16 (the inner wall surface of the cylinder head 12) from the intake port 17 side (the right side in the drawing) to the exhaust port 18 side (the left side in the drawing). After that, the tumble flow flows along an inner wall surface of the cylinder 13 on the exhaust port 18 side toward the piston 14 side. Then, after flowing along the crown surface of the piston 14 from the exhaust port 18 side to the intake port 17 side, the tumble flow flows along the inner wall surface of the cylinder 13 on the intake port 17 side toward the intake port 17 side.

The method of creating the tumble flow in the combustion chamber 16 is not limited to the method of adjusting the sectional shape of the intake port 17 and the sectional shape of the combustion chamber 16 as described above. A control valve that causes a bias in the flow of the intake air flowing in the intake port 17 may be provided in the intake port 17 and an opening degree of the control valve may be adjusted so as to create the tumble flow.

Although not shown, an intake valve for opening and closing the openings of the combustion chamber 16 and the intake port 17, an exhaust valve for opening and closing the openings of the combustion chamber 16 and the exhaust port 18, an intake camshaft that drives the intake valve to open and close, and an exhaust camshaft that drives the exhaust valve to open and close are attached to the cylinder head 12.

The first fuel injection valve 2 is attached to, for example, an intake manifold 19 constituting a part of the intake passage such that fuel can be injected into the intake port 17. A valve opening time (injection amount) and a valve opening timing (injection timing) of the first fuel injection valve 2 are changed by a control signal from the electronic control unit 200. When the first fuel injection valve 2 is opened, fuel is injected from the first fuel injection valve 2 into the intake port 17, and the fuel is supplied to the combustion chamber 16. Note that, the first fuel injection valve 2 may be attached to, for example, the cylinder head 12 such that the fuel can be directly injected into the combustion chamber 16.

The second fuel injection valve 3 is attached to the cylinder head 12 such that fuel can be injected in the same direction as the flow direction of the tumble flow flowing along the top surface of the combustion chamber 16 from the intake port 17 side to the exhaust port 18 side, and further, can be directly injected into a space near an electrode portion 4a of the spark plug 4. In the present embodiment, the second fuel injection valve 3 is attached between the pair of intake ports 17a, 17b as shown in FIG. 2. The valve opening time (injection amount) and the valve opening timing (injection timing) of the second fuel injection valve 3 are changed by a control signal from the electronic control unit 200. When the second fuel injection valve 3 is opened, fuel is injected from the second fuel injection valve 3 into the combustion chamber 16, whereby the fuel is supplied to the combustion chamber 16.

The spark plug 4 is attached to the cylinder head 12 in a manner such that the electrode portion 4a of the spark plug 4 faces the combustion chamber 16. In the present embodiment, the spark plug 4 is attached between the pair of exhaust ports 18a, 18b as shown in FIG. 2. The spark plug 4 generates a spark in the combustion chamber 16 and ignites the air-fuel mixture created in the combustion chamber 16. The ignition timing of the spark plug 4 is controlled to an arbitrary timing by a control signal from the electronic control unit 200.

The electronic control unit 200 is composed of a digital computer and includes a read-only memory (ROM) 202, a random access memory (RAM) 203, a central processing unit (CPU; microprocessor) 204, an input port 205, and an output port 206 that are connected to each other by a bidirectional bus 201.

An output signal of a load sensor 211 that generates an output voltage proportional to a depression amount of an accelerator pedal 221 (hereinafter referred to as “accelerator depression amount”) is input to the input port 205 as a signal for detecting the engine load. Further, as a signal for calculating an engine rotation speed or the like, an output signal of a crank angle sensor 212 that generates an output pulse every time the crankshaft of the engine main body 1 rotates by, for example, 15° is input to the input port 205. Further, as a signal for detecting the temperature of the engine main body 1, an output signal of a coolant temperature sensor 213 that detects the temperature of a coolant for cooling the engine main body 1 (hereinafter referred to as “engine coolant temperature”) is input to the input port 205. Note that, the signal for detecting the temperature of the engine main body 1 is not limited to the output signal of the coolant temperature sensor 213. When an oil temperature sensor that detects the temperature of lubricating oil that lubricates a frictional sliding portion of the engine main body 1 is provided, an output signal of the oil temperature sensor may be used. Further, an output signal of a knock sensor 214 for detecting knocking is input to the input port 205. In the present embodiment, a vibration sensor (acceleration sensor) equipped with a piezoelectric element and outputting a voltage value corresponding to the vibration acceleration of the engine main body 1 is used as the knock sensor 214. However, the knock sensor 214 is not limited to this, and various known sensors capable of detecting knocking, such as an in-cylinder pressure sensor and an optical sensor, can be used as the knock sensor 214. As described above, the output signals of various sensors necessary for controlling the internal combustion engine 100 are input to the input port 205.

The output port 206 is connected to each of control components, such as the first fuel injection valve 2, the second fuel injection valve 3, and the spark plug 4, via a corresponding drive circuit 208.

The electronic control unit 200 outputs a control signal for controlling each control component from the output port 206 based on the output signals of various sensors input to the input port 205 and controls the internal combustion engine 100.

Hereinafter, the control of the internal combustion engine 100 executed by the electronic control unit 200 will be described.

The electronic control unit 200 switches an operation mode of the engine main body 1 to a stoichiometric combustion mode or a lean combustion mode in accordance with the temperature of the engine main body 1 (in the present embodiment, the engine coolant temperature). Specifically, the electronic control unit 200 switches the operation mode of the engine main body 1 to the stoichiometric combustion mode when the temperature of the engine main body 1 is lower than a predetermined temperature, that is, when the engine is cold where ignitability of the air-fuel mixture and, by extension, the combustion stability relatively deteriorate. On the other hand, when the temperature of the engine main body 1 is equal to or higher than the predetermined temperature, the electronic control unit 200 switches the operation mode of the engine main body 1 to the lean combustion mode.

When the operation mode is the stoichiometric combustion mode, the electronic control unit 200 carries out a homogeneous combustion in which a homogeneous air-fuel mixture at the stoichiometric air-fuel ratio or near the stoichiometric air-fuel ratio is created in the combustion chamber 16 and the homogeneous air-fuel mixture created is ignited to cause flame propagation combustion so as to operate the engine main body 1.

Specifically, when the operation mode is the stoichiometric combustion mode, the electronic control unit 200 creates the homogeneous air-fuel mixture at the stoichiometric air-fuel ratio or near the stoichiometric air-fuel ratio in the combustion chamber 16 by injecting fuel in a target fuel injection amount corresponding to required torque from the first fuel injection valve 2 during an arbitrary period from the exhaust stroke of the previous combustion cycle to the intake stroke of the current combustion cycle. Then, the electronic control unit 200 ignites the homogeneous air-fuel mixture with the spark plug 4 at the optimum ignition timing (a knock limit timing when the optimum ignition timing is on the advance side of the knock limit ignition timing) to cause the flame propagation combustion so as to operate the engine main body 1.

On the other hand, when the operation mode is the lean combustion mode, the electronic control unit 200 carries out the lean combustion in which a stratified air-fuel mixture in which an ignition air-fuel mixture (second air-fuel mixture) having a higher fuel ratio than that of the ambient air-fuel mixture (first air-fuel mixture) is unevenly distributed near the electrode portion 4a of the spark plug 4 and that is leaner than the stoichiometric air-fuel ratio is created in the combustion chamber 16, and the stratified air-fuel mixture created is ignited to cause the flame propagation combustion so as to operate the engine main body 1.

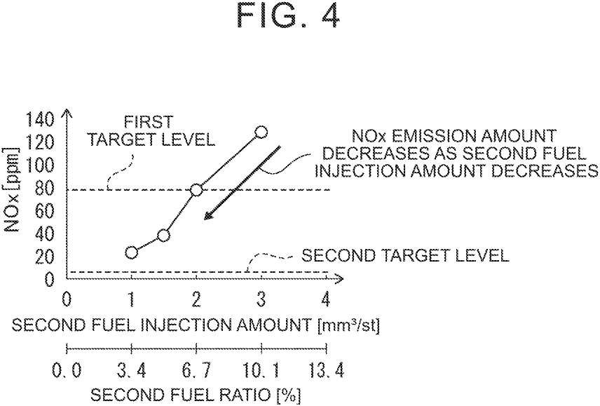

FIG. 3 shows an example of the fuel injection timing of each of the first fuel injection valve 2 and the second fuel injection valve 3 and the ignition timing in the lean combustion mode, with the in-cylinder pressure (MPa) on the vertical axis and the crank angle (deg. after top dead center (ATDC)) on the horizontal axis.

As shown in FIG. 3, when the operation mode is the lean combustion mode, first, the electronic control unit 200 causes the first fuel injection valve 2 to inject the first fuel during an arbitrary period from the exhaust stroke of the previous combustion cycle to the intake stroke of the current combustion cycle to diffuse the first fuel over the entire combustion chamber 16, and creates the homogeneous air-fuel mixture that is leaner than the stoichiometric air-fuel ratio (hereinafter referred to as a “first air-fuel mixture”) in the combustion chamber 16.

Next, the electronic control unit 200 causes the second fuel injection valve 3 to inject a second fuel for assisting the ignition (ignition fuel) to the space near the electrode portion 4a of the spark plug 4 during the compression stroke (in the present embodiment, during the period from 20 (deg. crank angle (CA)) before the ignition timing to the ignition timing). With the above, before the second fuel is diffused over the entire combustion chamber 16, the ignition air-fuel mixture having a higher fuel ratio than that of the first air-fuel mixture (hereinafter referred to as a “second air-fuel mixture”) is temporarily created near the electrode portion 4a of the spark plug 4 so as to create the stratified air-fuel mixture in the combustion chamber 16. An excess air factor λ₀ of the stratified air-fuel mixture is set to 2.0 or more, and is set to around 3.0 in the present embodiment. Then, the electronic control unit 200 ignites the second air-fuel mixture to propagate the flame from the second air-fuel mixture to the first air-fuel mixture to cause the flame propagation combustion of the stratified air-fuel mixture so as to operate the engine main body 1.

As described above, the second air-fuel mixture having a relatively high fuel ratio is temporarily created near the electrode portion 4a of the spark plug 4 and the second air-fuel mixture created is ignited, whereby misfire can be suppressed and the combustion stability of the stratified air-fuel mixture can be ensured even when a lean stratified air-fuel mixture of which the excess air factor exceeds 2.0 is created in the combustion chamber 16 as in the present embodiment. Then, as the stratified air-fuel mixture becomes leaner, the combustion temperature can be lowered and the NOx emission amount can be reduced.

On the other hand, when the excess air factor λ₀ of the stratified air-fuel mixture is the same, as an excess air factor λ₂ of the second air-fuel mixture is lowered (as the degree of richness of the second air-fuel mixture is increased), the combustion stability of the stratified air-fuel mixture is more improved. However, this results in an increase in the combustion temperature of the second air-fuel mixture, and by extension, in an increase in the stratified air-fuel mixture, and thus the NOx emission amount increases.

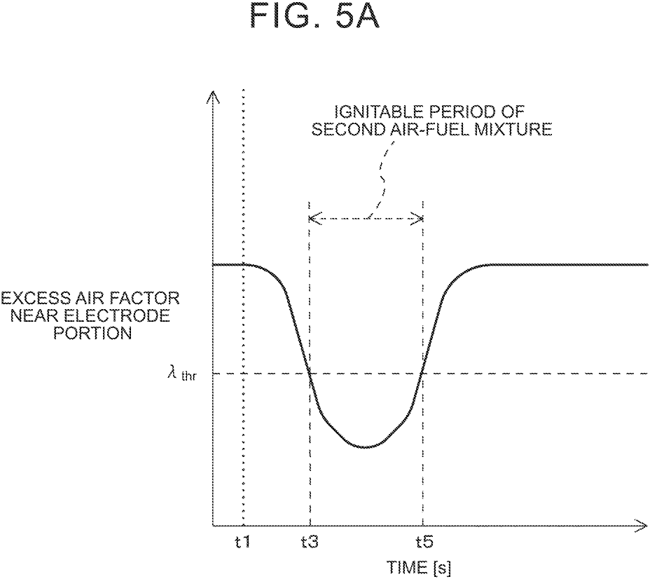

FIG. 4 is a diagram showing a change in the NOx emission amount when only the second fuel injection amount (mm³/stroke (st)) is changed to change the ratio (%) of the second fuel injection amount (hereinafter referred to as a “second fuel ratio”) to the entire fuel injection amount (in this example, approximately 30 (mm³/st)) while the excess air factor λ₀ of the stratified air-fuel mixture (the average excess air factor of the air-fuel mixture in the combustion chamber) is kept constant (λ₀ = 2.7 in this example), that is, when the excess air factor λ₀ is not changed and only the excess air factor λ₂ of the second air-fuel mixture is changed, under the operating conditions with the same engine load and engine rotation speed.

As shown in FIG. 4, as the second fuel injection amount is reduced to lower the second fuel ratio, the degree of richness of the second air-fuel mixture also becomes smaller, whereby the combustion temperature of the second air-fuel mixture, and by extension, the stratified air-fuel mixture, can be lowered and the NOx emission amount can be reduced.

Further, in FIG. 4, a first target level and a second target level of the NOx emission amount in the lean combustion mode are shown by broken lines, respectively. The first target level corresponds to the NOx emission amount from the homogeneous air-fuel mixture that is made lean to reach the ignition limit by spark ignition when a lean homogeneous combustion in which the homogeneous air-fuel mixture that is leaner than the stoichiometric air-fuel ratio is created in the combustion chamber 16 and flame propagation combustion is caused is carried out so as to reduce the NOx emission amount. The second target level is a target value for the NOx emission amount that is stricter than the first target level, and corresponds to the regulation value for the NOx emission amount stipulated by the European emission standards (EURO 7).

As shown in FIG. 4, it can be understood that the second fuel injection amount needs to be suppressed to approximately 2.0 (mm³/st) or less in order to achieve the first target level. Further, it can be understood that the second fuel injection amount needs to be further reduced from the value above to achieve the second target level.

In other words, the minimum injection amount of the second fuel injection valve 3 needs to be set to be equal to or lower than a predetermined first injection amount capable of achieving the first target level so as to achieve the first target level, and the minimum injection amount of the second fuel injection valve 3 needs to be set to be equal to or less than a predetermined second injection amount capable of achieving the second target level so as to achieve the second target level.

The “minimum injection amount” of the fuel injection valve is the minimum injection amount in a full lift region of the fuel injection valve, and is a total fuel amount to be injected during a period in which a partial lift region is switched to the full lift region, that is, a lift amount of a needle valve of the fuel injection valve (hereinafter referred to as a “needle lift amount”) reaches the maximum lift amount from zero. The partial lift region is an injection region in which the needle lift amount of the fuel injection valve is smaller than the maximum lift amount, and the full lift region is an injection region after the needle lift amount of the fuel injection valve reaches the maximum lift amount.

In the present embodiment, the needle lift amount, an injection hole diameter, the number of injection holes, a fuel pressure and the like of the second fuel injection valve 3 are adjusted such that the minimum injection amount of the second fuel injection valve 3 is set to be less than the second injection amount, and the injection amount per unit time in the full lift region of the second fuel injection valve 3 (hereinafter referred to as a “fuel injection rate”) is approximately within the range from 1.0 (mm³/ms) to 3.0 (mm³/ms). The reason why the fuel injection rate of the second fuel injection valve 3 is kept within a certain range as described above is as follows.

As the fuel injection rate of the second fuel injection valve 3 becomes smaller, the time required to completely inject a predetermined amount of fuel from the second fuel injection valve 3 is lengthened. This is because, when the fuel injection rate is made too small, the second fuel diffuses into the combustion chamber 16 before the second fuel is completely injected from the second fuel injection valve 3, and the excess air factor λ₂ of the second air-fuel mixture cannot be maintained to be equal to or less than a predetermined excess air factor λₜₕᵣ at which stable ignition by the spark plug 4 is possible. On the other hand, when the fuel injection rate of the second fuel injection valve 3 is made too large, the second fuel injection amount cannot be suppressed to be equal to or less than the first injection amount or the second injection amount. That is, this is because, when the fuel injection rate of the second fuel injection valve 3 is not kept within a certain range, the appropriate second air-fuel mixture capable of stable ignition by the spark plug 4 and having the excess air factor at which the NOx emission amount can be suppressed to be the first target level or the second target level or less cannot be created.

To stably ignite the second air-fuel mixture by the spark plug 4, the ignition timing needs to be adjusted to a period during which the excess air ratio λ₂ of the second air-fuel mixture is equal to or less than the predetermined excess air factor λₜₕᵣ (the ignitable period of the second air-fuel mixture). More specifically, it is necessary to secure a predetermined length of period or longer as an overlap period between the ignitable period of the second air-fuel mixture and the period during which the electrode portion 4a of the spark plug 4 is discharged. It is experimentally known that the predetermined excess air factor λₜₕᵣ is approximately 1.3, and the predetermined period is approximately 250 (µs).

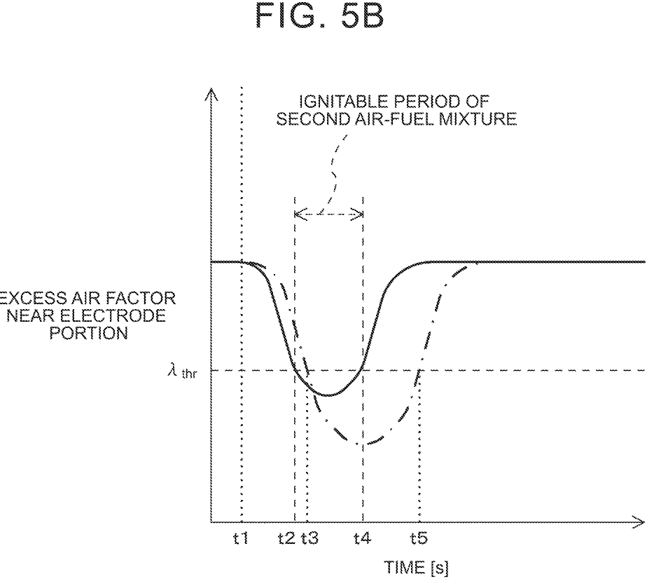

The ignitable period of the second air-fuel mixture varies corresponding to the second fuel injection amount. This point will be described with reference to FIGS. 5A and 5B.

FIG. 5A shows a time change of the excess air factor (corresponding to the excess air factor λ₂ of the second air-fuel mixture) near the electrode portion 4a of the spark plug 4 after the second fuel is injected from the second fuel injection valve 3.

As shown in FIG. 5A, when the second fuel is injected at time t1, the excess air factor near the electrode portion 4a of the spark plug 4 temporarily decreases. As a result, in the example shown in FIG. 5A, the excess air factor near the electrode portion 4a of the spark plug 4 is equal to or less than the predetermined excess air rate λₜₕᵣ in the period from time t3 to time t5 after a predetermined time has elapsed from time t1. Therefore, the period from time t3 to time t5 is the ignitable period of the second air-fuel mixture.

FIG. 5B is a diagram showing a time change of the excess air factor near the electrode portion 4a of the spark plug 4 when the second fuel injection amount is made smaller than that in the example shown in FIG. 5A. Note that, FIG. 5B shows an example shown in FIG. 5A as an alternate long and short dash line for comparison.

In the example shown in FIG. 5B (see the solid line), the second fuel injection amount is reduced as compared with the example shown in FIG. 5A (see the alternate long and short dash line). Therefore, a degree of decrease in the excess air factor near the electrode portion 4a of the spark plug 4 is smaller than the example shown in FIG. 5A. As a result, in the example shown in FIG. 5B, the excess air factor near the electrode portion 4a of the spark plug 4 is the predetermined excess air rate λₜₕᵣ or less in the period from time t2 after a predetermined time has elapsed from time t1 to time t4, and it can be understood that the ignitable period of the second air-fuel mixture becomes shorter than the example shown in FIG. 5A. Further, it can be understood that the period from when the second fuel is injected to when the excess air factor near the electrode portion 4a of the spark plug 4 becomes the predetermined excess air factor λₜₕᵣ or less (the period from time t1 to time t2 in the example shown in FIG. 5B, and the period from time t1 to time t3 in the example shown in FIG. 5A) also changes.

As described above, the ignitable period of the second air-fuel mixture changes in accordance with the second fuel injection amount, and the ignitable period of the second air-fuel mixture becomes shorter as the second fuel injection amount decreases. Then, as described above with reference to FIG. 4, the second fuel injection amount needs to be approximately 2.0 (mm3/st) (≈ the first injection amount) that is a minute injection amount even when the NOx emission amount is set to the first target level. In particular, in the present embodiment, the second fuel injection amount is reduced to be a further minute injection amount (< the second injection amount) such that the NOx emission amount can be suppressed to less than the second target level. Therefore, the ignitable period of the second air-fuel mixture becomes very short.

Here, as shown in FIGS. 5A and 5B, the excess air factor near the electrode portion 4a of the spark plug 4 becomes the predetermined excess air ratio λₜₕᵣ for a certain period after a predetermined time has elapsed from injection of the second fuel. Therefore, when the retard correction is applied to the ignition timing to suppress knocking when knocking occurs, the retard correction also needs to be applied to the second fuel injection timing in accordance with the retard correction of the ignition timing to adjust the ignition timing to the ignitable period of the second air-fuel mixture.

However, as the ignitable period of the second air-fuel mixture becomes shorter, it becomes more difficult to adjust the ignition timing to the ignitable period of the second air-fuel mixture when the retard correction is applied to the second fuel injection timing in accordance with the retard correction of the ignition timing. Therefore, it is highly likely that the second air-fuel mixture cannot be ignited. When the second fuel injection amount is reduced from the initial amount due to the change in the characteristics of the second fuel injection valve 3 over time, the ignitable period of the second air-fuel mixture is further shortened. Therefore, it becomes more difficult to adjust the ignition timing to the ignitable period of the second air-fuel mixture. In particular, when it is necessary to set the second fuel injection amount to a minute injection amount as in the present embodiment, the injection hole diameter of the second fuel injection valve 3 tends to be small, and the number of injection holes tends to be small. Therefore, for example, the effect is significant when a deposit is accumulated in the injection hole, and the characteristics of the second fuel injection valve 3 tend to change and the second fuel injection amount tends to decrease.

Therefore, in the present embodiment, when the retard correction is applied to the ignition timing to suppress knocking when knocking occurs, the retard correction is applied to the second fuel injection timing in accordance with the retard correction of the ignition timing, and further, the increase correction is applied to the second fuel injection amount. With the above, the ignitable period of the second air-fuel mixture can be lengthened by the increased amount of the second fuel injection amount, whereby it is possible to suppress an inability to ignite the second air-fuel mixture because the ignition timing cannot be adjusted to the ignitable period of the second air-fuel mixture.

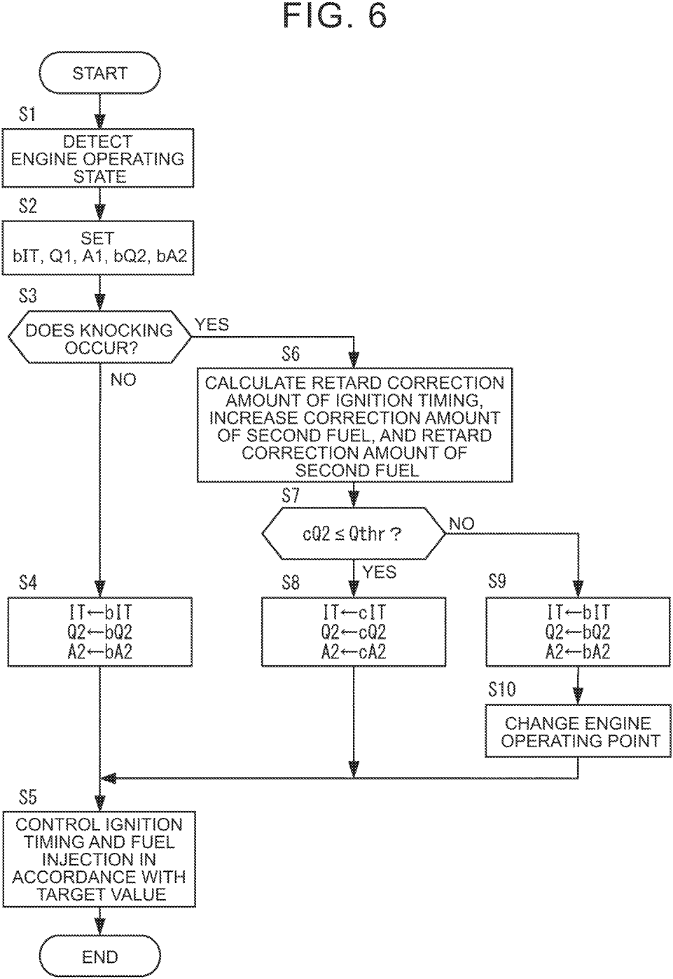

Hereinafter, knocking suppression control executed in the lean combustion mode according to the present embodiment will be described with reference to the flowchart in FIG. 6. The electronic control unit 200 repeatedly executes this routine in a predetermined calculation cycle in the lean combustion mode.

In step S1, the electronic control unit 200 reads an engine rotation speed calculated based on the output signal of the crank angle sensor 212 and the engine load detected by the load sensor 211, and detects the engine operating state (an engine operating point defined by the engine rotation speed and the engine load).

In step S2, the electronic control unit 200 sets a basic ignition timing bIT of the spark plug 4, a target injection amount Q1 and a target injection timing A1 of the first fuel, and a basic injection amount bQ2 and a basic injection timing bA2 of the second fuel. In the present embodiment, the electronic control unit 200 refers to a map or the like stored in the ROM 202 in advance, and sets the basic ignition timing bIT of the spark plug 4, the target injection amount Q1 and the target injection timing A1 of the first fuel, and the basic ignition timing bA2 of the second fuel based on the engine operating state. Further, the electronic control unit 200 sets the basic injection amount bQ2 of the second fuel to a predetermined injection amount that is present regardless of the engine operating state. In the present embodiment, the predetermined injection amount is set to an injection amount that is smaller than the second injection amount that achieves the second target level of the NOx emission amount.

In step S3, the electronic control unit 200 determines whether knocking occurs based on the output signal of the knock sensor 214. The electronic control unit 200 proceeds to a process in step S4 when knocking does not occur. On the other hand, the electronic control unit 200 proceeds to a process in step S6 when knocking occurs.

In step S4, the electronic control unit 200 sets the basic ignition timing bIT as a target ignition timing IT without correction, and similarly sets the basic injection amount bQ2 and the basic ignition timing bA2 of the second fuel as the target injection amount Q2 and the target injection timing A2 of the second fuel, respectively, without correction.

In step S5, the electronic control unit 200 controls the first fuel injection valve 2 such that the injection amount and injection timing of the first fuel become the target injection amount Q1 and the target injection timing A1, and controls the second fuel injection valve 3 such that the injection amount and the injection timing of the second fuel becomes the target injection amount Q2 and the target injection timing A2. Further, the electronic control unit 200 controls the spark plug 4 such that the ignition timing becomes the target ignition timing IT.

In step S6, the electronic control unit 200 refers to a map or the like stored in the ROM 202 in advance, and calculates a retard correction amount of the ignition timing, an increase correction amount of the second fuel, and a retard correction amount of the injection timing of the second fuel based on the engine operating state.

In step S7, the electronic control unit 200 calculates a corrected injection amount cQ2 by adding the increase correction amount to the basic injection amount bQ2 of the second fuel, and determines whether the corrected injection amount cQ2 is equal to or less than the predetermined upper limit injection amount Qthr. In the present embodiment, the upper limit injection amount Qthr is set as the second injection amount that achieves the second target level of the NOx emission amount.

When the corrected injection amount cQ2 of the second fuel is equal to or less than the upper limit injection amount Qthr, the NOx emission amount can be suppressed to the second target level or lower even when the increase correction is applied to the injection amount of the second fuel in accordance with the retard correction of the ignition timing. Therefore, the electronic control unit 200 proceeds to processes in step S8 and later so as to enable stable ignition of the second air-fuel mixture by suppressing knocking by applying the retard correction to the ignition timing and correcting the injection amount and the injection timing of the second fuel in accordance with the retard correction of the ignition timing.

On the other hand, when the corrected injection amount cQ2 is larger than the upper limit injection amount Qthr, the NOx emission amount exceeds the second target level when the increase correction is applied to the injection amount of the second fuel in accordance with the retard correction of the ignition timing. Therefore, the electronic control unit 200 proceeds to processes in step S9 and later so as to suppress knocking by changing the engine operating point, rather than suppressing knocking by applying the retard correction to the ignition timing.

In step S8, the electronic control unit 200 sets a corrected ignition timing cIT that is retarded by the retard correction amount from the basic ignition timing bIT as the target ignition timing IT, sets the corrected injection amount cQ2 obtained by increasing the basic injection amount bQ2 by the increase correction amount as the target injection amount Q2 of the second fuel, and sets a corrected injection timing cA2 obtained by retarding the basic ignition timing bA2 by the retard correction amount as the target injection timing A2 of the second fuel.

In step S9, the electronic control unit 200 sets the basic ignition timing bIT as the target ignition timing IT without correction, and similarly sets the basic injection amount bQ2 and the basic ignition timing bA2 of the second fuel as the target injection amount Q2 and the target injection timing A2 of the second fuel, respectively, without correction.

In step S10, the electronic control unit 200 changes the engine operating state to the engine operating state where knocking is difficult to occur. Specifically, knocking is a phenomenon in which the temperature and the pressure of the unburned pre-mixed air-fuel mixture (end gas) that is difficult for flame propagation to reach becomes high and self-ignites before the flame propagation reaches, and as the engine operating point is located in an operation region on the lower rotation and higher load side, knocking is more likely to occur. Therefore, the engine operating point is moved from the current engine operating point to the engine operating point to the high rotation side and the low load side.

As a method of moving the engine operating point to the high rotation side, for example, when an output shaft of the internal combustion engine 100 is connected to a transmission, a method in which the shift stage or the gear ratio of the transmission is changed in a direction to increase the engine rotation speed is exemplified. Further, as a method of moving the engine operating point to the low load side, for example, a method in which loads of various accessories driven using the power of the internal combustion engine 100 (for example, the power generation load of an alternator and a drive load of an air conditioner compressor) are lowered is exemplified.

In the present embodiment, in step S10, the engine operating point is moved from the current engine operating point to the high rotation side and the low load side. However, the engine operating point may be moved to any one of the high rotation side and the low load side.

The internal combustion engine 100 according to the present embodiment described above includes: the engine main body 1; the spark plug 4 provided with the electrode portion 4a disposed to face the combustion chamber 16 of the engine main body 1; the first fuel injection valve 2 that injects fuel into an intake passage or the combustion chamber 16 of the engine main body 1; the second fuel injection valve 3 that injects fuel into the combustion chamber 16; the knock sensor 214 for detecting a vibration of the engine main body 1; and the electronic control unit 200 (control device).

The electronic control unit 200 carries out the lean combustion of which the excess air factor is 2.0 or more by injecting the first fuel for creating a homogeneous air-fuel mixture in the combustion chamber 16 from the first fuel injection valve 2, injecting the second fuel (ignition fuel) for creating the second air-fuel mixture (ignition air-fuel mixture) near the electrode portion 4a from the second fuel injection valve 3, and igniting the second air-fuel mixture, and when occurrence of knocking is detected based on a detection value of the knock sensor 214 during the lean combustion, apply retard correction to each of the ignition timing of the spark plug 4 and the injection timing of the second fuel set corresponding to the engine operating state, and apply increase correction to the injection amount of the second fuel.

With the above, even when the retard correction is applied to the injection timing of the second fuel in accordance with the retard correction of the ignition timing so as to suppress knocking, the ignitable period of the second air-fuel mixture can be lengthened by the increase amount of the second fuel injection amount. With the above, it is possible to suppress the inability to ignite the second air-fuel mixture because the ignition timing cannot be adjusted to the ignitable period of the second air-fuel mixture, whereby the combustion stability when the knocking suppression control is executed during the lean combustion can be ensured.

Further, the electronic control unit 200 according to the present embodiment changes the engine operating point defined by the engine rotation speed and the engine load in a direction to suppress knocking (to at least any one of the engine high rotation side and the engine low load side) without applying the retard correction to each of the ignition timing of the spark plug 4 and the injection timing of the second fuel and applying the increase correction to the injection amount of the second fuel when the injection amount of the second fuel after the increase correction is larger than the predetermined upper limit injection amount Qthr (upper limit value).

As described above with reference to FIG. 4, when the excess air factor λ₀ of the stratified air-fuel mixture is the same, the NOx emission amount increases as the excess air factor λ₂ of the second air-fuel mixture is made smaller, that is, as the second fuel injection amount is increased. Therefore, setting the upper limit of the second fuel injection amount can suppress the NOx emission amount to a certain value or less, and can ensure the combustion stability while knocking is suppressed when knocking occurs.

In particular, in the present embodiment, the electronic control unit 200 is configured to correct the injection amount of the second fuel to increase from the predetermined basic injection amount bQ2 (the reference injection amount) that is preset. The basic injection amount bQ2 is set to an injection amount capable of suppressing the NOx emission amount to be the second target level or less, and the upper limit injection amount Qthr (upper limit value) is set to an injection amount capable of setting the NOx emission amount to achieve the second target level. Therefore, it is possible to suppress the NOx emission amount from exceeding the second target level, and to secure the combustion stability while knocking is suppressed when knocking occurs.

Further, the engine main body 1 of the internal combustion engine 100 according to the present embodiment is configured to be able to generate, in the combustion chamber 16, the tumble flow that flows from the intake port 17 opening to the top surface of the combustion chamber 16 toward the exhaust port 18, and passes through the electrode portion 4a, and the second fuel injection valve 3 injects fuel directly toward the electrode portion 4a in the same direction as the flow direction of the tumble flow.

With the above, the flame generated by igniting the second air-fuel mixture temporarily created near the electrode portion 4a can be moved on the tumble flow across the entire combustion chamber 16. Therefore, the flame is easily to be propagated to the entire combustion chamber 16, whereby the combustion stability during the lean combustion can further be ensured.

Although the embodiment of the present disclosure have been described above, the embodiment is only a part of the application examples of the present disclosure, and the technical aspects of the present disclosure are not intended to be limited to the specific configuration of the above embodiment.

For example, in the above embodiment, when the corrected injection amount cQ2 is larger than the upper limit injection amount Qthr, the engine operating point defined by the engine rotation speed and the engine load is changed in the direction to suppress occurrence of knocking without applying the retard correction to each of the ignition timing of the spark plug 4 and the injection timing of the second fuel and the increase correction to the injection amount of the second fuel. However, the present disclosure is not limited to this, and for example, when the corrected injection amount cQ2 is larger than the upper limit injection amount Qthr, the engine operating point defined by the engine rotation speed and the engine load may be changed in the direction to suppress occurrence of knocking in addition to the retard correction applied to each of the ignition timing of the spark plug 4 and the injection timing of the second fuel while the corrected injection amount cQ2 is suppressed to be equal to or less than the upper limit injection amount Qthr.

Further, in the above embodiment, the internal combustion engine 100 includes the first fuel injection valve 2 for creating a homogeneous air-fuel mixture in the combustion chamber and the second fuel injection valve 3 for creating the ignition air-fuel mixture in the combustion chamber. However, for example, when there is any fuel injection valve in which the number of injection holes and the needle lift amount are flexibly variable and that can simultaneously satisfy the injection performances required for the first fuel injection valve 2 and the second fuel injection valve 3, one fuel injection valve that is configured as described above and in which the first fuel injection valve 2 and the second fuel injection valve 3 are integrated may be provided to inject fuel into the combustion chamber.

In the above embodiment, the reason for the configuration in which the first fuel injection valve 2 for creating the homogeneous air-fuel mixture in the combustion chamber is provided separately from the second fuel injection valve 3 for creating the ignition air-fuel mixture in the combustion chamber is as follows.

As described above, the fuel injection rate of the second fuel injection valve 3 needs to be kept within a certain range to create the appropriate second air-fuel mixture capable of stable ignition by the spark plug 4 and having the excess air factor at which the NOx emission amount can be suppressed to be equal to or less than the first target level or the second target level.

In the case where the first fuel for creating the homogeneous air-fuel mixture in the combustion chamber is injected from the second fuel injection valve 3 separately from the second fuel without providing the first fuel injection valve 2 under the condition that the fuel injection rate of the second fuel injection valve 3 is kept within a certain range, the fuel injection rate becomes too low to complete injection of the entire amount of the fuel amount required for creating the homogeneous air-fuel mixture within the fuel injection period during which the homogeneous air-fuel mixture can be created when the target fuel injection amount is increased as the required torque is increased, that is, the fuel amount for creating the homogeneous air-fuel mixture to be injected from the second fuel injection valve 3 (that is, the first fuel amount) is increased. Therefore, in the above embodiment, the first fuel injection valve 2 for creating the homogeneous air-fuel mixture in the combustion chamber and the second fuel injection valve 3 for creating the ignition air-fuel mixture in the combustion chamber are used in combination.

Further, in the above embodiment, it is not necessary to carry out the lean combustion in which the fuel amount of the second fuel (ignition fuel) is set to be equal to or less than the first injection amount or the second injection amount in the entire area of the engine operating region where the lean combustion of which the excess air factor is 2.0 or more is carried out, and, for example, the lean combustion may be carried out only in a predetermined engine operating region where NOx emission is desired to be suppressed while the combustion stability is ensured.

What is claimed is:

1. An internal combustion engine comprising:
an engine main body;
a spark plug provided with an electrode portion disposed to face a combustion chamber of the engine main body;
a first fuel injection valve that injects fuel into an intake passage or the combustion chamber of the engine main body;
a second fuel injection valve that injects fuel into the combustion chamber;
a knock sensor for detecting a vibration of the engine main body; and
a control device, wherein
the control device
carries out a lean combustion of which excess air factor is 2.0 or more by injecting fuel for creating a homogeneous air-fuel mixture in the combustion chamber from the first fuel injection valve, injecting ignition fuel for creating an ignition air-fuel mixture near the electrode portion from the second fuel injection valve, and igniting the ignition air-fuel mixture, and
when occurrence of knocking is detected based on a detection value of the knock sensor during the lean combustion, applies retard correction to each of an ignition timing of the spark plug and an injection timing of the ignition fuel set corresponding to an engine operating state, and applies increase correction to an injection amount of the ignition fuel.

2. The internal combustion engine according to claim 1, wherein when the injection amount of the ignition fuel after the increase correction is larger than a predetermined upper limit value, the control device changes an engine operating point defined by an engine rotation speed and an engine load in a direction to suppress occurrence of knocking without applying the retard correction to each of the ignition timing of the spark plug and the injection timing of the ignition fuel and applying the increase correction to the injection amount of the ignition fuel.

3. The internal combustion engine according to claim 2, wherein when the injection amount of the ignition fuel after the increase correction is larger than the predetermined upper limit value, the control device limits the injection amount of the ignition fuel to be equal to or less than the upper limit value, and changes the engine operating point defined by the engine rotation speed and the engine load in the direction to suppress occurrence of knocking.

4. The internal combustion engine according to claim 2, wherein the control device changes the engine operating point such that the engine rotation speed is changed to the high rotation side.

5. The internal combustion engine according to claim 2, wherein the control device changes the engine operating point such that the engine load is changed to the low load side.

6. The internal combustion engine according to claim 1, wherein the control device applies the increase correction to the injection amount of the ignition fuel from a predetermined reference injection amount that is preset.

7. The internal combustion engine according to claim 6, wherein the reference injection amount is an injection amount by which a NOx emission amount of the internal combustion engine is able to be suppressed to be less than a predetermined target level.

8. The internal combustion engine according to claim 2, wherein:
the control device applies the increase correction to the injection amount of the ignition fuel from a predetermined reference injection amount that is preset;
the reference injection amount is an injection amount by which a NOx emission amount of the internal combustion engine is able to be suppressed to be less than a predetermined target level; and
the upper limit value is an injection amount by which the NOx emission amount of the internal combustion engine becomes the predetermined target level.

9. The internal combustion engine according to claim 1, wherein:
the engine main body is configured to be able to generate, in the combustion chamber, a tumble flow that flows from an intake port opening to a top surface of the combustion chamber toward an exhaust port, and passes through the electrode portion; and
the second fuel injection valve injects fuel directly toward the electrode portion in the same direction as a flow direction of the tumble flow.
